(19) United States
(12) Patent Application Publication
(10) Pub. No.: US 2012/0249471 A1
(43) Pub. Date: Oct. 4, 2012

(54) METHOD OF IDENTIFYING A MULTI-TOUCH ROTATION GESTURE AND DEVICE USING THE SAME

(75) Inventors: Lianfang YI, Shenzhen (CN); Tiejun Cai, Shenzhen (CN); Hailiang Jiang, Shenzhen (CN); Bangjun He, Shenzhen (CN); Yun Yang, Shenzhen (CN)

(73) Assignee: BYD COMPANY LIMITED, Shenzhen (CN)

(21) Appl. No.: 13/355,466

(22) Filed: Jan. 20, 2012

(30) Foreign Application Priority Data
Mar. 31, 2011 (CN) 201110081235.4

(51) Int. Cl. G06F 3/041; G06F 3/043; G06F 3/042; G06F 3/044

(52) U.S. Cl. 345/174; 345/173

(57) ABSTRACT

A method of identifying a rotation gesture comprises detecting one or more induction signals induced by one or more pointing objects that come into contact with a touch-sensitive surface, determining the number of the pointing object that come into contact with a touch screen, determining a rotation gesture performed by the pointing objects if the number of the pointing object is more than one, generating a control signal associated with the determined rotation gesture and executing a rotation command in response to the generated control signal.

### CROSS-REFERENCE TO RELATED APPLICATION

This application claims priority under 35 U.S.C. §119 to Chinese Patent Application No. 201110081235.4, filed on Mar. 31, 2011, the content of which is incorporated herein by reference in its entirety.

### TECHNICAL FIELD

Example embodiments of the present disclosure relate generally to a method of identifying gestures on a touchpad, and more particularly, to a method of identifying a rotation gesture and device thereof.

### BACKGROUND

Although the keyboard remains a primary input device of a computer, the prevalence of graphical user interfaces (GUIs) may require use of a mouse or other pointing device such as a trackball, joystick, touchpad or the like. Operations performed by the pointing devices generally correspond to moving a cursor, making selections, dragging, zoom in/out, rotating or the like.

Touchpads are commonly used on portable electronic devices by providing a panel for user's fingers or other conductive objects to touch or move thereon. Operations on touchpads may be implemented by detecting hand gestures. For example, selections may be made when one or more taps are detected on the touchpads. In addition to selections, moving a selected content from one place to another may be made by dragging a user's finger across the touchpad.

### SUMMARY

According to one exemplary embodiment of the present invention, a method of identifying multi-touch rotation gesture comprises detecting one or more induction signals induced by one or more pointing objects that come into contact with a touch-sensitive surface, determining the number of the pointing object that come into contact with a touch screen, determining a rotation gesture performed by the pointing objects if the number of the pointing object is more than one, generating a control signal associated with the determined rotation gesture and executing a rotation command in response to the generated control signal.

According to one exemplary embodiment of the present invention, a device of identifying multi-touch points comprises a detecting module, a determination module, a rotation gesture determining module, a signal generation module and a processing unit. The detecting module is configured to detect one or more induction signals induced by one or more pointing objects that come into contact with a touch-sensitive surface. The determination module is configured to determine the number of pointing objects. The rotation gesture determining module is configured to determine a rotation gesture performed by the pointing objects. The signal generation module is configured to generate a control signal associated with the determined rotation gesture. The processing unit is configured to execute a rotation command in response to the generated control signal.

### BRIEF DESCRIPTION OF THE DRAWINGS

Having thus described example embodiments of the present disclosure in general terms, reference will now be made to the accompanying drawings, which are not necessarily drawn to scale, and wherein:

FIG. 1 illustrates a block diagram of a touch gesture identifying device according to one exemplary embodiment of the present invention;

FIG. 2 illustrates a schematic diagram of inductive lines on a touch pad according to one exemplary embodiment of the present invention;

FIG. 3 illustrates a block diagram of a determination module according to one exemplary embodiment of the present invention;

FIG. 4 illustrates a block diagram of a rotation gesture determining module according to one exemplary embodiment of the present invention;

FIG. 5 illustrates a communication between a gesture identification device and a terminal application device according to exemplary embodiments of the present invention;

FIG. 6 illustrates a method of identifying the number of pointing objects that contact the touch screen according to one exemplary embodiment of the present invention;

FIGS. 7-9 illustrate diagrams of a detected induction signal and a reference signal according to one exemplary embodiment of the present invention;

FIG. 10 is a flow chart illustrating a method of identifying a rotation gesture according to one exemplary embodiment of the present invention;

FIGS. 11 and 13 illustrate methods of identifying a rotation gesture at step 1008 of FIG. 10 according to exemplary embodiments of the present invention; and

FIGS. 12 and 14 illustrate diagrams of rotation gestures according to exemplary embodiments of the present invention.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In this regard, although example embodiments may be described herein in the context of a touch screen or touch-screen panel, it should be understood that example embodiments are equally applicable to any of a number of different types of touch-sensitive surfaces, including those with and without an integral display (e.g., touchpad). Also, for example, references may be made herein to axes, directions and orientations including X-axis, Y-axis, vertical, horizontal, diagonal, right and/or left; it should be understood, however, that any direction and orientation references are simply examples and that any particular direction or orientation may depend on the particular object, and/or the orientation of the particular object, with which the direction or orientation reference is made. Like numbers refer to like elements throughout.

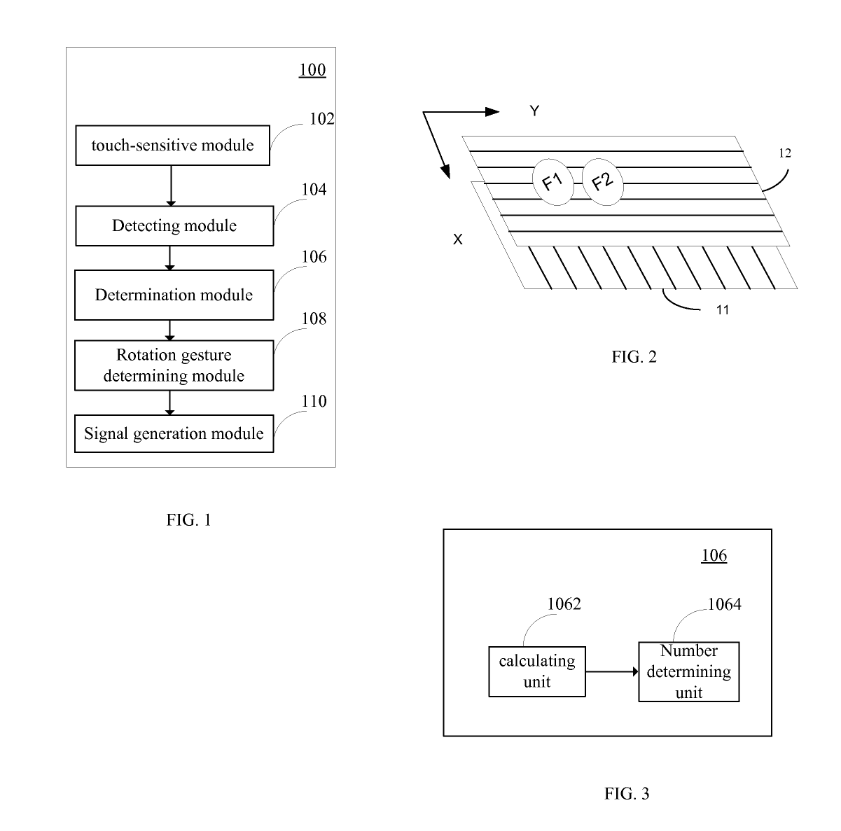

FIG. 1 illustrates a schematic diagram of a device of identifying a rotation gesture 100 according to an exemplary embodiment of the present invention (“exemplary” as used herein referring to “serving as an example, instance or illustration”). As explained below, the gesture identification device 100 may be configured to determine a gesture and generate corresponding control signals based on coordinates of multi-touch points on a touch screen.

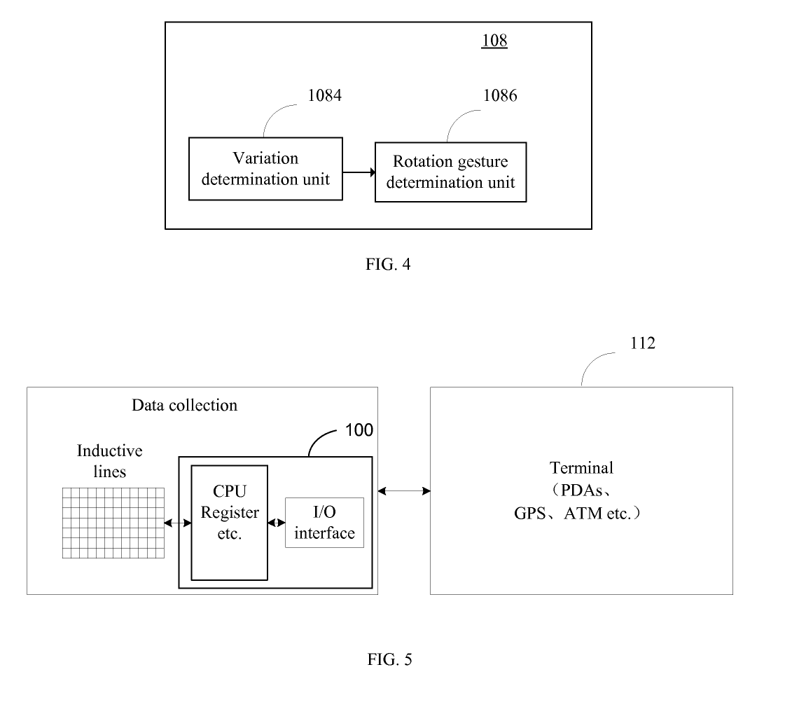

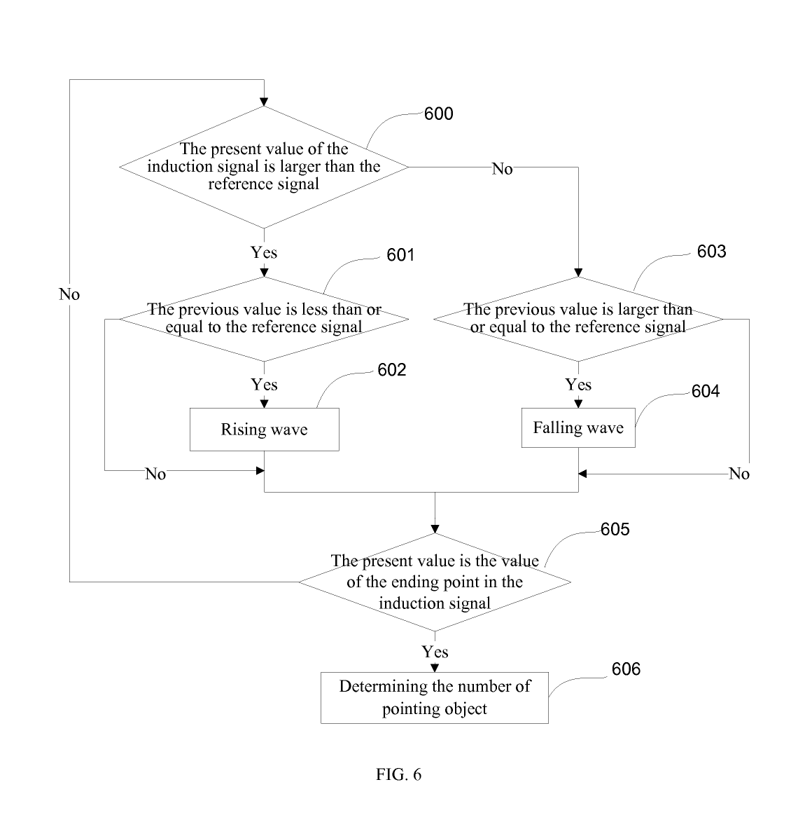

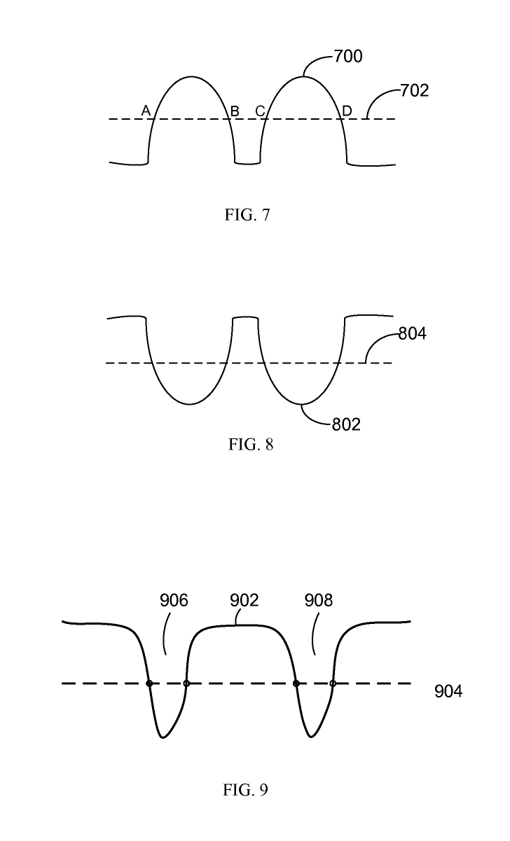

As illustrated in FIG. 1, the gesture identification device 100 may include a touch-sensitive module 102, a detecting module 104, a determination module 106, a rotation gesture determining module 108, and a signal generation module 110. The touch-sensitive module 102 of one example may be as illustrated in FIG. 2. The determination module 106 may include a calculating unit 1062 and a number determining unit 1064 as illustrated in FIG. 3. The rotation gesture determining module 108 may include a variation determination unit 1084 and a rotation gesture determination unit 1086 as illustrated in FIG. 4.

FIG. 2 illustrates a schematic diagram of a touch-sensitive surface according to one exemplary embodiment of the present invention. The touch-sensitive module 102 may include a plurality of inductive lines 11 and 12 on respective X and Y axes to form the touch-sensitive surface. In other exemplary embodiments, the touch-sensitive module 102 may comprise an acoustic sensor, optical sensor or other kind of sensor to form a touch-sensitive surface for sensing the touch by the pointing objects. The X and Y axes may be perpendicular to each other, or have a specific angle other than 90°. As also shown, F1 and F2 indicate two touch points on the touch-sensitive module 102 by two pointing objects according to an exemplary embodiment. The touch-sensitive module 102 may be embodied in a number of different manners forming an appropriate touch-sensitive surface, such as in the form of various touch screens, touchpads or the like. As used herein, then, reference may be made to the touch-sensitive module 102 or a touch-sensitive surface (e.g., touch screen) formed by the touch-sensitive module.

In operation, when a pointing object, such as a user's finger or a stylus is placed on the touch screen, the touch-sensitive module 102 may generate one or more induction signals induced by the pointing object. The generated induction signals may be associated with a change in electrical current, capacitance, acoustic waves, electrostatic field, optical fields or infrared light. The detecting module 104 may detect the induction signals associated with the change induced by one or more pointing objects, such as two pointing objects in one or more directions on the touch screen. In an instance in which two pointing objects are simultaneously applied to the touch screen, the calculating module 1062 may determine the number of pointing objects applied to the touch screen based on the number of rising waves and/or the number of falling waves of the induction signal. The number determining unit 1064 may output the calculated result to the rotation gesture determining module 108. The calculating unit 1062 may comprise a comparison unit (not shown) to compare values of the detected induction signal with a reference signal to determine at least one of the number of rising waves and the number of falling waves of the detected induction signal.

In one exemplary embodiment, there may be a plurality of pointing objects in contact with the touch screen. The variation determination unit 1084 may obtain relative movements of each pointing object. Based on the result obtained by the variation determination unit 1084, the rotation gesture determination unit 1086 may determine whether the pointing objects perform a rotation gesture. The signal generation module 110 may generate corresponding control signals. The gesture identification device 100 may further comprises a processing unit (not shown). The processing unit may be configured to interact with the terminal application device based on the control signals, such as by executing a rotation on a display of the terminal application device.

As described herein, the touch-sensitive module 102 and the processing unit are implemented in hardware, alone or in combination with software or firmware. Similarly, the detecting module 104, the determination module 106, the rotation gesture determination module 108 and the signal generation module 110 may each be implemented in hardware, software or firmware, or some combination of hardware, software and/or firmware. As hardware, the respective components may be embodied in a number of different manners, such as one or more CPUs (Central Processing Units), microprocessors, coprocessors, controllers and/or various other hardware devices including integrated circuits such as ASICs (Application Specification Integrated Circuits), FPGAs (Field Programmable Gate Arrays) or the like. As will be appreciated, the hardware may include or otherwise be configured to communicate with memory, such as volatile memory and/or non-volatile memory, which may store data received or calculated by the hardware, and may also store one or more software or firmware applications, instructions or the like for the hardware to perform functions associated with operation of the device in accordance with exemplary embodiments of the present invention.

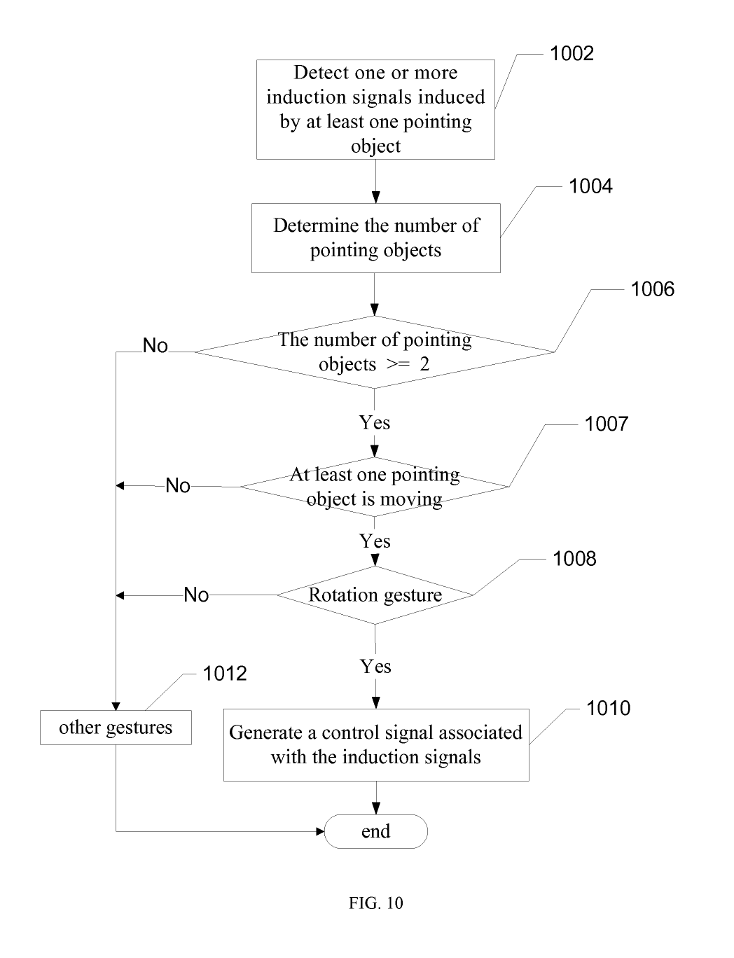

FIG. 5 illustrates a schematic diagram illustrating communications between the gesture identification device 100 and a terminal application device 112 according to exemplary embodiments of the present invention. The gesture identification device 100 may be configured to provide the control signals and other related information to a processing unit (not shown) of the terminal application device 112 to execute the gesture applied to the touch-sensitive module 102. The terminal application device 112 may be any of a number of different processing devices including, for example, a laptop computer, desktop computer, server computer, or a portable electronic devices such as a portable music player, mobile telephone, portable digital assistant (PDA), tablet or the like. Generally, the terminal application device 112 may include the processing unit, memory, user interface (e.g., display and/or user input interface) and/or one or more communication interfaces. The touch screen may be a resistive touch screen, a capacitive touch screen, an infrared touch screen, an optical imaging touch screen, an acoustic pulse touch screen, surface acoustic touch screen or in any other forms.

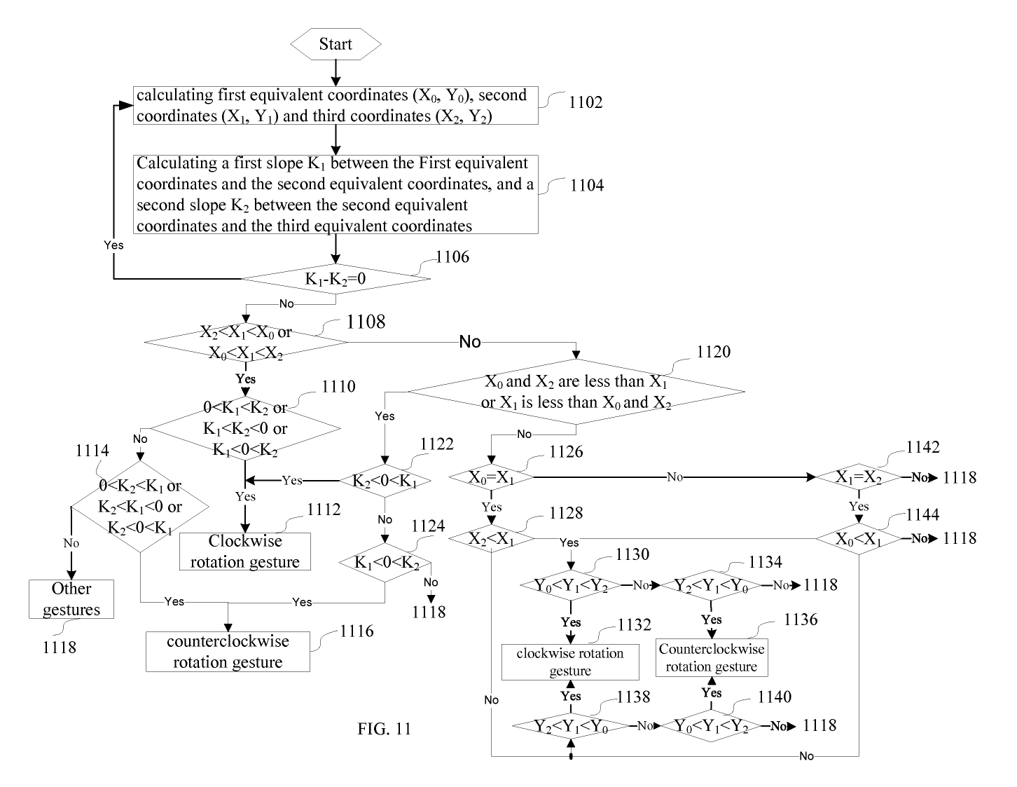

FIG. 6 illustrates a method of determining the number of pointing objects that contact the touch screen according to one exemplary embodiment of the present invention. When at least one pointing object is in contact with the touch screen, an induction signal sensed and generated by the touch-sensitive module 102 may be detected by the detecting module 104. At step 600, a present value of the induction signal is compared to a reference signal by the calculating unit 1062. In an instance in which the present value is larger than the reference signal, a previous value of the induction signal is compared to the reference signal by the comparison unit (not shown) of the calculating unit 1062. In an instance in which the previous value is less than or equal to the reference signal at step 601, the wave is determined as a rising wave at step 602. In an instance in which the previous value is larger than or equal to the reference signal, the determination module 106 may determine if the present value is the last value in the induction signal at step 605. If it is determined as the last value, the number of pointing objects may be determined at step 606 based on the number of rising waves and/or the number of falling waves and may be output by the number determining unit 1064 to the rotation gesture determining module 608.

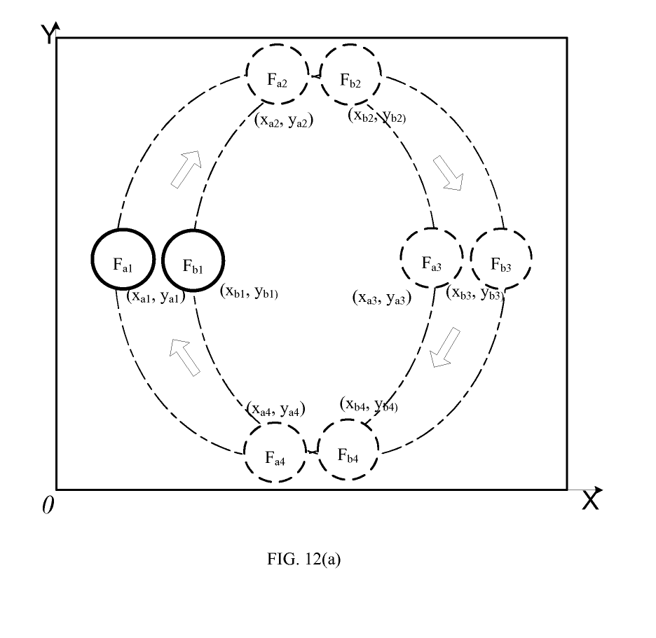

In an instance in which the present value is less than or equal to the reference signal at step 600, the previous value is compared to the reference signal at step 603. In an instance in which the previous value is larger than or equal to the reference signal, the wave is determined as a falling wave at step 604. The process may proceed to step 605 to determine if the present value is the last value in the induction signal. In an instance in which the present value is not the last value in the induction signal at step 605, the process may otherwise proceed to select a next value and compare the next value to the reference signal at step 601. In an exemplary embodiment, if the number of the rising waves is not equal to that of the falling waves, the process may await next induction signals. In one exemplary embodiment, a first initial induction value and a second initial induction value may be predetermined. In the exemplary embodiment as illustrated in FIG. 7, the first initial induction value and the second initial induction value are predetermined less than the reference signal. In another exemplary embodiment as illustrated in FIG. 8, the first initial induction value and the second initial induction value are predetermined larger than the reference signal. The first initial induction value is preceding the first point of the detected induction signal and the last point of the detected signal is preceding the second initial induction value. In this manner, the first value of the detected induction signal and the predetermined first initial induction value may be compared to the reference signal. The predetermined second initial induction value and the last value of the detected signal may be compared to the reference signal.

FIG. 7 illustrates a diagram of a detected induction signal 700 and a reference signal 702 according to one exemplary embodiment of the present invention. In an instance in which a pointing object comes into contact with the touch screen at a touch point, the contact at that touch point may induce the touch-sensitive module 102 to generate the induction signal 700. Accordingly, the number of rising waves or the number of falling waves may corresponds to the number of pointing objects that are in contact with the touch screen. The rising wave may cross the reference signal at points A and C (referred as “rising point”). The falling wave may cross the reference signal at points B and D (referred as “drop point”). Due to some unexpected noises, the induction signal may not be induced by a valid contact of a pointing object. To determine whether an induction signal induced by a valid contact, the distance between one rising point and a subsequent drop point may be measured and compared to a predetermined threshold value by the calculating unit 1062. If the distance is larger than the predetermined threshold value, the induction signal is determined to be induced by a valid touch. For example, the distance between the rising point A and its subsequent drop point B may be measured and compared to a predetermined threshold value TH₁.

Different induction signal waves may be obtained due to different analyzing methods or processing methods. FIG. 8 illustrates an induction signal 802 induced by a contact with the touch screen and a reference signal 804 according to an exemplary embodiment. The method of determining a valid contact at a touch point and the number of touch points may be similar to that is described above. To determine whether an induction signal induced by a valid contact, the distance between one drop point and a subsequent rising point may be measured and compared to a predetermined threshold value by the calculating unit 1062. If the distance is larger than the predetermined threshold value, the induction signal is determined to be induced by a valid touch.

Touch points may be determined by measuring the attenuation of waves, such as ultrasonic waves, across the surface of the touch screen. For instance, the processing unit may send a first electrical signal to a transmitting transducer. The transmitting transducer may convert the first electrical signal into ultrasonic waves and emit the ultrasonic waves to reflectors. The reflectors may refract the ultrasonic waves to a receiving transducer. The receiving transducer may convert the ultrasonic waves into a second electrical signal and send it back to the processing unit. When a pointing object touches the touch screen, a part of the ultrasonic wave may be absorbed causing a touch event that may be detected by the detecting module 104 at that touch point. Coordinates of the touch point are then determined. An attenuated induction signal 902 crossed by a reference signal 904 and two attenuation parts 906 and 908 are illustrated in FIG. 9.

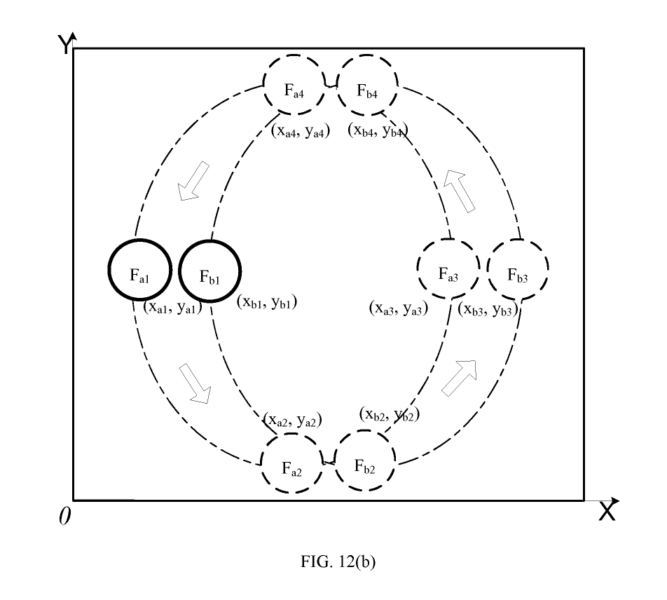

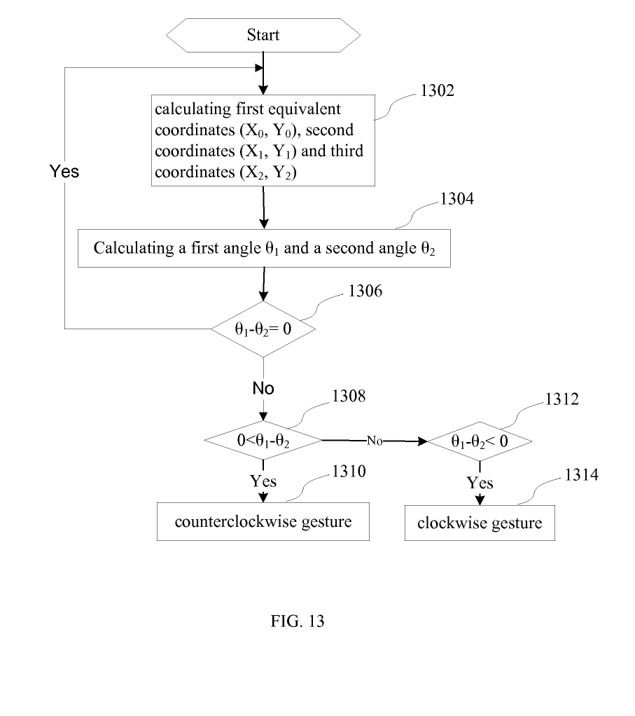

FIG. 10 illustrates various steps in a method of identifying a rotation gesture according to one exemplary embodiment of the present invention. When a pointing object, such as a finger, comes into contact with the touch screen at a touch point, the touch-sensitive module 102 may sense the contact and generate one or more induction signals. There may be a plurality of pointing objects that simultaneously come into contact with the touch screen to perform a gesture, and which pointing objects may induce a plurality of detectable induction signals at step 1002. The determination module 106 may determine the number of pointing objects applied to the touch screen based on the number of rising waves and/or the number of falling waves of the induction signal at step 1004. The determination module 106 may detect that if there are at least two pointing objects that come into contact with the touch screen at step 1006. The moving statuses of each pointing object may be determined by the rotation gesture determining module 1086 at step 1007. At step 1008, the rotation gesture determination unit 1086 may determine if the at least two pointing objects are performing a rotation gesture, which will be detailed in FIGS. 11-14. In an instance in which the operation is determined as a rotation gesture, an associated control signal may be generated by the signal generation module 110 at step 1010. A rotation operation associated with the generated control signal is then executed. In an instance in which the operation is not a rotation gesture, the method proceeds to step 1012. The processing unit may perform other operations to determine what gesture is applied to the touch-screen.

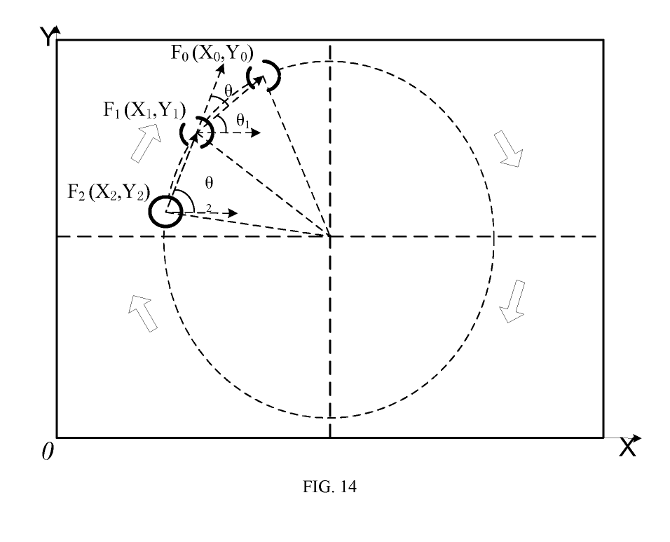

FIG. 11 illustrates a method of identifying a rotation gesture at step 1008 of FIG. 10 according to an exemplary embodiment of the present invention. When it is determined that there are at least two pointing objects that come into contact with the touch screen, the moving statuses of each pointing object may be recorded. In an instance in which two pointing objects are moving, coordinates of each touch point associated with each pointing object are recorded by the variation determination unit 1084. The distance between touch points that are simultaneously touched by the pointing objects is calculated. For instance, as illustrated in FIGS. 12(a) and 12(b), when a first pointing object rests on the touch screen on a touch point Fₐ₁ and a second pointing object simultaneously rests on the touch screen on a touch point F_{b1}, coordinates (xₐ₁, yₐ₁) of the touch point Fₐ₁ and coordinates (x_{b1}, y_{b1}) of the touch point F_{b1} are recorded. Distance between the first pair of touch points Fₐ₁ and F_{b1} Dₐ₁=\sqrt{(yₐ₁−y_{b1})²+(xₐ₁−xₐ₂)²} is calculated by the rotation gesture determination unit 1086. Similarly, distances between each pair of touch points (Fₐ₂ and F_{b2}, Fₐ₃ and F_{b3}, Fₐ₄ and F_{b4}) which are simultaneously touched by the first and second pointing objects are calculated. In an instance in which distance between each pair of touch points is less than a predetermined threshold value TH₂, equivalent coordinates are calculated by the rotation gesture determining module 1086 at step 1102, based on the coordinates of each touch point. For instance, first equivalent coordinates (X₀, Y₀) associated with the first pair of touch points Fₐ₁ and F_{b1} are calculated based on the coordinates (xₐ₁, yₐ₁) and (x_{b1}, y_{b1}). Similarly, second equivalent coordinates (X₁, Y₁) associated with the second pair of touch points Fₐ₂ and F_{b2} are calculated based on the coordinates (xₐ₂, yₐ₂) and (x_{b2}, y_{b2}). Third equivalent coordinates (X₂, Y₂) associated with the third pair of touch points Fₐ₃ and F_{b3} are calculated based on the coordinates (xₐ₃, yₐ₃) and (x_{b3}, y_{b3}).

At step 1104, a first slope

$${K}_{1} = \frac{{Y}_{0} - {Y}_{1}}{{X}_{0} - {X}_{1}}$$

between the first equivalent coordinates (X₀, Y₀) and the second equivalent coordinates (X₁, Y₁), and a second slope

$${K}_{2} = \frac{{Y}_{1} - {Y}_{2}}{{X}_{1} - {X}_{2}}$$

between the second equivalent coordinates (X₁, Y₁) and the third equivalent coordinates (X₂, Y₂), are calculated. In an instance in which K₁−K₂=0, the method proceeds back to step 1102 to obtain new coordinates of each touch point and calculate new equivalent coordinates. In an instance in which K₁−K₂≠0 at step 1106, if X₀ or X₂, but not both, is greater than X₁ at step 1108 (X₂<X₁<X₀ or X₀<X₁<X₂), and if the first slope K₁ and the second slope K₂ satisfy one of the conditions at step 1110 (0<K₁<K₂ or K₁<K₂<0 or K₁<0<K₂), a clockwise rotation gesture may be executed at step 1112 as illustrated in FIG. 12(a). In an instance in which the first slope K₁ and the second slope K₂ satisfy none of the conditions at step 1110, but one of the conditions at step 1114 (0<K₂<K₁ or K₂<K₁<0 or K₂<0<K₁) a counterclockwise rotation gesture may be executed at step 1116 as illustrated in FIG. 12(b). If the first slope K₁ and the second slope K₂ satisfy none of the conditions at step 1114, the method may proceed to step 1118 to determine if any other gesture is applied to the touch-screen.

In an instance in which X₁ is larger or less than both X₀ and X₂ at step 1120, i.e., X₀ and X₂ are less than X₁ or X₁ is less than X₀ and X₂, and if the first slope K₁ is larger than zero and the second slope K₂ is less than zero (K₂<0<K₁) at step 1122, a clockwise rotation gesture may be executed at step 1112, as illustrated in FIG. 12(b). If the result obtained at step 1122 is No and the first slope K₁ is less than zero and the second slope K₂ is larger than zero (K₁<0<K₂) at step 1124, a counterclockwise rotation gesture may be executed at step 1116. In an instance in which the result obtained at step 1120 is No, and X₀ is equal to X₁ at step 1126, if X₂ is less than X₀ (X₁) at step 1128, and Y₁ is less than Y₂ and larger than Y₀ (Y₀<Y₁<Y₂) at step 1130, a clockwise rotation gesture is executed at step 1132, as illustrated in FIG. 12(a). In an instance in which the result obtained at step 1130 is No and Yᵢ is less than Y₀ and larger than Y₂ (Y₂<Y₁<Y₀) at step 1134, a counterclockwise rotation gesture is executed at step 1136.

In an instance in which X₂ is larger than X₀ (X₁) at step 1128, and Y₁ is less than Y₀ and larger than Y₂ (Y₂<Y₁<Y₀) at step 1138, a clockwise rotation gesture is executed at step 1132. In an instance in which X₂ is larger than X₀ (X₁) at step 1128, and Y₁ is less than Y₂ and larger than Y₀ (Y₀<Y₁<Y₂), the method proceeds to step 1140. A clockwise rotation gesture is executed at step 1136.

In an instance in which X₁ is not equal to X₀ (X₁≠X₀), at step 1126, but X₁ is equal to X₂ (X₁=X₀) at step 1142, and X₀ is less than X₁ (X₂) at step 1144, as described above the method proceeds to steps 1130 or 1134 to determine a clockwise rotation gesture at step 1132, as illustrated in FIG. 12(a), or a counterclockwise rotation gesture at step 1136, as illustrated in FIG. 12(b). In an instance in which X₀ is greater than X₁ (X₂) at step 1144 or X₂ is greater than X₀ (X₁) at step 1128, and Y₁ is less than Y₀ and larger than Y₂ (Y₂<Y₁<Y₀) at step 1138, a clockwise rotation gesture is executed at step 1132. If the result obtained at step 1138 is No, and Y₁ is less than Y₂ and larger than Y₀ (Y₀<Y₁<Y₂) at step 1140, a counterclockwise rotation gesture is executed at step 1136. A control signal associated with a rotation gesture that is determined at steps 1112, 1116, 1132 and 1136 may be generated to execute a corresponding operation on the terminal application device, such as volume adjustment, photo rotation, paging and the like. In an instance in which the result obtained at step 1124, 1134, 1140, 1142 or 1144 is No, the method may proceed to step 1118 to determine if any other gesture is applied to the touch-screen.

FIG. 13 illustrates a method of identifying a rotation gesture at step 1008 of FIG. 10 according to an exemplary embodiment of the present invention. As described above, the first equivalent coordinates (X₀, Y₀) associated with the first pair of touch points Fₐ₁ and F_{b1}, the second equivalent coordinates (X₁, Y₁) associated with the second pair of touch points Fₐ₂ and F_{b2} and the third equivalent coordinates (X₂, Y₂) associated with the third pair of touch points Fₐ₃ and F_{b3} are calculated by the rotation gesture determining module 1086 at steps 1302, based on the coordinates of the touch points associated with the pointing objects Fₐ and F_{b}. When a control signal associated with a rotation gesture is generated, the control signal may comprise information about a rotation angle. The rotation angle may be defined between the line connecting two adjacent equivalent coordinates and X-axis. For instance, with reference to FIG. 14, a first rotation angle θ₁ is between the line connecting the first equivalent coordinates (X₀, Y₀) and the second equivalent coordinates (X₁, Y₁), and X-axis. A second rotation angle θ₂ is between the line connecting the second equivalent coordinates (X₁, Y₁) and the third equivalent coordinates (X₂, Y₂), and X-axis. The rotation angle may be obtained through various mathematic methods, such as tangent, vector or cosine. In one instance, the rotation angle is obtained through tangent. The first rotation angle

$${θ}_{1} = arctan \frac{{Y}_{0} - {Y}_{1}}{{X}_{0} - {X}_{1}}$$

and the second angle

$${θ}_{2} = arctan \frac{{Y}_{1} - {Y}_{2}}{{X}_{1} - {X}_{2}}$$

are calculated by the rotation gesture demining module 1086 at step 1304. In an instance in which θ₁-θ₂ is equal to 0 at step 1306, the method proceeds back to step 1302 to obtain new coordinates of each touch point and calculate new equivalent coordinates. In an instance in which θ₁-θ₂ is not equal to 0 at step 1306, but greater than 0 at step 1308, a counterclockwise rotation gesture is executed at step 1310. In an instance in which θ₁-θ₂ is not equal to 0 at step 1306, but less than 0 at step 1312, a clockwise rotation gesture is executed at step 1314. A control signal associated with a rotation gesture that is determined at steps 1310 and 1314 may be generated to execute a corresponding operation on the terminal application device, such as volume adjustment, photo rotation, paging and the like.

All or a portion of the system of the present invention, such as all or portions of the aforementioned processing unit and/or one or more modules of the gesture identification device 100, may generally operate under control of a computer program product. The computer program product for performing the methods of embodiments of the present invention includes a computer-readable storage medium, such as the non-volatile storage medium, and computer-readable program code portions, such as a series of computer instructions, embodied in the computer-readable storage medium.

FIGS. 6, 10, 11 and 13 are flowcharts of methods, systems and program products according to the invention. It will be understood that each block or step of the flowcharts, and combinations of blocks in the flowcharts, can be implemented by computer program instructions. These computer program instructions may be loaded onto a computer or other programmable apparatus to produce a machine, such that the instructions which execute on the computer or other programmable apparatus create means for implementing the functions specified in the block(s) or step(s) of the flowcharts. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the flowcharts. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block(s) or step(s) of the flowcharts.

Accordingly, blocks or steps of the flowcharts support combinations of means for performing the specified functions, combinations of steps for performing the specified functions and program instruction means for performing the specified functions. It will also be understood that each block or step of the flowcharts, and combinations of blocks or steps in the flowcharts, can be implemented by special purpose hardware-based computer systems which perform the specified functions or steps, or combinations of special purpose hardware and computer instructions.

It will be appreciated by those skilled in the art that changes could be made to the examples described above without departing from the broad inventive concept. It is understood, therefore, that this invention is not limited to the particular examples disclosed, but it is intended to cover modifications within the spirit and scope of the present invention as defined by the appended claims.

What is claimed is:

1. A method of identifying a rotation gesture comprising:
detecting one or more induction signals induced by one or more pointing objects that come into contact with a touch-sensitive surface;
determining the number of the pointing objects;
determining a rotation gesture performed by the pointing objects;
generating a control signal associated with the determined rotation gesture; and
executing a rotation command in response to the generated control signal.

2. The method of claim 1, wherein determining the number of pointing objects comprises:
selecting a first point and a second point of each detected induction signal, the second point preceding the first point;
comparing values of the two selected points to a reference signal to determine a rising wave or a falling wave; and
determining the number of rising waves and/or falling waves to determine the number of pointing objects.

3. The method of claim 2, wherein comparing values comprises:
comparing a first value of the first point to the reference signal;
comparing a second value of the second point to the reference signal; and
determining a rising wave or a falling wave according to the comparison results.

4. The method of claim 3 further comprising:
identifying one or more rising points on the rising wave intercepted by the reference signal;
identifying one or more drop points on the falling wave intercepted by the reference signal; and
comparing a distance between a rising point and a subsequent drop point to a predetermined threshold value or comparing a distance between a drop point and a subsequent rising point to a predetermined threshold value to determine if the detected induction signal is induced by a valid contact.

5. The method of claim 4, further comprising:
detecting a first induction signal in a first direction; and
detecting a second induction signal in a second direction, wherein the first direction and the second direction have an angel therebetween.

6. The method of claim 5, furthering comprising:
determining the number of the pointing objects according to the number of rising waves or falling waves of the first induction signal or the second induction signal.

7. The method of claim 1, wherein the pointing objects come into contact with the touch-sensitive surface at respective touch points, and wherein the method further comprises:
obtaining coordinates of at least three subsequent touch points associated with each pointing object;
calculating distances between the touch points that are simultaneously touched by the pointing objects;
comparing the distances to a second threshold; and
determining a rotation gesture based on the comparison result.

8. The method of claim 7, determining a rotation gesture comprises:
calculating first, second and third equivalent coordinates based on the coordinates of the at least three touch points associated with each pointing object; and
determining a rotation gesture based on the first, second and third equivalent coordinates and a rotation rate of the rotation gesture according to a difference of a first slope between the first equivalent coordinates and the second equivalent coordinates and a second slope between the second equivalent coordinates and the third equivalent coordinates.

9. The method of claim 8, wherein determining a rotation gesture further comprises:
calculating a first slope between the first and second equivalent coordinates;
calculating a second slope between the second and third equivalent coordinates; and
determining a rotation gesture based on the first slope and the second slope.

10. The method of claim 8, wherein determining a rotation gesture further comprises:
calculating a first angle between the line connecting the first and second equivalent coordinates and X-axis;
calculating a second angle between the line connecting the second and third equivalent coordinates and X-axis; and
determining a rotation gesture based on the first angle and the second angle.

11. A device of identifying a rotation gesture comprising:
a detecting module, configured to detect one or more induction signals induced by one or more pointing objects that come into contact with a touch-sensitive surface;
a determination module, configured to determine the number of pointing objects;
a rotation gesture determining module, configured to determine a rotation gesture performed by the pointing objects;
a signal generation module, configured to generate a control signal associated with the determined rotation gesture; and
a processing unit, configured to execute a rotation command in response to the generated control signal.

12. The device of claim 11, wherein the determination module further comprises:
a calculating unit, configured to compare values of a first and a second points to a reference signal to determine at least one of the number of rising waves and the number of falling waves to thereby determine the number of pointing objects; and
a number determining unit, configure to determine the number of pointing objects that generate the induction signals according to the number of the rising waves and the falling waves.

13. The device of claim 12, wherein the comparing unit further comprises a
comparing unit configured to:
comparing values of two adjacent points of the detected induction signals to a reference signal to determine a rising wave or a falling wave; and
determining the number of rising waves and/or falling waves to determine the number of pointing objects.

14. The device of claim 11, wherein the determination module is configured to:
identify one or more rising points on the rising wave intercepted by the reference signal;
identify one or more drop points on the falling wave intercepted by the reference signal; and
compare a distance between a rising point and a subsequent drop point to a predetermined threshold value or compare a distance between a drop point and a subsequent rising point to a predetermined threshold value to determine if the detected induction signal is induced by a valid contact.

15. The device of claim 11, wherein the detecting module configured to detect a change in at least one of electrical current, capacitance, acoustic waves, electrostatic field, optical fields and infrared light.

16. The device of claim 11, wherein the detecting module comprises:
a transmitting transducer, configured to convert a first electrical signal into an acoustic signal and emit the acoustic signal to a reflector; and
a receiving transducer, configured to receive the acoustic signal from the reflector, convert the acoustic signal into a second electrical signal and send the second electrical signal to the processing unit.

17. The device of claim 11, wherein the rotation gesture determining module further comprises:
a variation determination unit, configured to obtain coordinates of touch points associated with the pointing objects and obtain the distances between touch points simultaneously touched by the pointing objects; and
a rotation gesture determination unit, configured to determine a rotation gesture based on the obtained coordinates.

18. The device of claim 17, wherein the rotation gesture determination unit is configured to:
calculate first, second and third equivalent coordinates based on the coordinates of at least three touch points associated with each pointing object; and
determine a rotation gesture based on the first, second and third equivalent coordinates.

19. The device of claim 17, wherein the rotation gesture determination unit is configured to:
calculate a first slope between the first and second equivalent coordinates;
calculate a second slope between the second and third equivalent coordinates; and
determine a rotation gesture based on the first slope and the second slope.

20. The device of claim 17, wherein the rotation gesture determination unit is configured to:
calculate a first angle between the line connecting the first and second equivalent coordinates and X-axis;
calculate a second angle between the line connecting the second and third equivalent coordinates and X-axis; and
determine a rotation gesture based on the first angle and the second angle.
